(19) United States
(12) Patent Application Publication
(10) Pub. No.: US 2015/0006037 A1
(43) Pub. Date: Jan. 1, 2015

(54) INTEGRATED SENSING SYSTEM FOR PARKING AID AND PEDESTRIAN IMPACT DETECTION

(71) Applicant: Ford Global Technologies, LLC, Dearborn, MI (US)

(72) Inventors: Mahmoud Yousef GHANNAM, Canton, MI (US); Abraham G. PHILIP, Rochester Hills, MI (US); David James TIPPY, Ann Arbor, MI (US); Yeruva Satya REDDY, Farmington, MI (US); Jennifer Danielle SHAW, Plymouth, MI (US); Tania VAZQUEZ, Benito Juarez (MX)

(73) Assignee: Ford Global Technologies, LLC, Dearborn, MI (US)

(21) Appl. No.: 14/273,914

(22) Filed: May 9, 2014

Related U.S. Application Data
(60) Provisional application No. 61/840,017, filed on Jun. 27, 2013.

(51) Int. Cl. B60Q 9/00; B60R 21/34

(52) U.S. Cl. CPC B60Q 9/006; B60R 21/34
USPC 701/45; 73/627

(57) ABSTRACT

A vehicle sensing system may include a plurality of sensing components, each component including a housing configured to maintain a first sensor and a second sensor, an interface connected to each of the first sensor and the second sensor, and a first module and a second module connected to the interface, each configured to receive data from at least one of the first sensor and the second sensor.

### CROSS-REFERENCE TO RELATED APPLICATIONS

This application claims the benefit of U.S. provisional application Ser. No. 61/840,017, filed Jun. 27, 2013, the disclosure of which is hereby incorporated in its entirety by reference herein.

### TECHNICAL FIELD

Disclosed herein is an integrated sensing system for parking aid and pedestrian impact detection.

### BACKGROUND

Vehicle control systems use data from various sensors throughout the vehicle. These sensors are often arranged on the bumper. There is a need for a simple, more compact, and cost effective sensing system that reduces the necessary components required for attaching sensors to the bumper and communicating data from the sensors to the control system.

### SUMMARY

A vehicle sensing system may include a plurality of sensing components, each component including a housing configured to maintain a first sensor and a second sensor, an interface connected to each of the first sensor and the second sensor, and a first module and a second module connected to the interface, each configured to receive data from at least one of the first sensor and the second sensor.

A sensing component may include a housing configured to maintain a first sensor and a second sensor, and an interface connected to each of the first sensor and the second sensor and configured to communicate with at least one vehicle control module.

A vehicle system may include a first control module coupled to a sensing component within the vehicle, the module configured to receive distance data from the sensing component and transmit a message to a second control module in response to the distance data indicating the presence of an object within a predefined proximity to the vehicle, the message including instructions to prepare at least one feature of the second control module to receive impact data from the sensing component.

### BRIEF DESCRIPTION OF THE DRAWINGS

FIG. 1 is a perspective view of an exemplary sensing component on the inside of a vehicle bumper;

FIG. 2 is a system diagram of an exemplary sensing system;

FIGS. 3A-3C are graphical representations of data received from sensors within the sensing system;

FIG. 4 is a top transparent view of an exemplary component;

FIG. 5 is a system diagram of a sensing system;

FIG. 6 is another system diagram of the sensing system;

FIG. 7 is another system diagram of the sensing system; and

FIG. 8 is a flow chart of the sensing system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a vehicle sensor system including a plurality of integrated sensing components. The sensing components include a housing configured to hold a pair of sensors such as a parking sensor and an impact sensor. The sensors are used by at least one of a restraint control module (RCM) and a parking aid module (PAM) of a vehicle. The pair of sensors use a single interface to communicate with the modules. By housing the pair of sensors in a single housing and using a single interface to communicate with the respective vehicle modules, the sensors may be easily arranged on the interior of a vehicle bumper without numerous components and burdensome installation procedures.

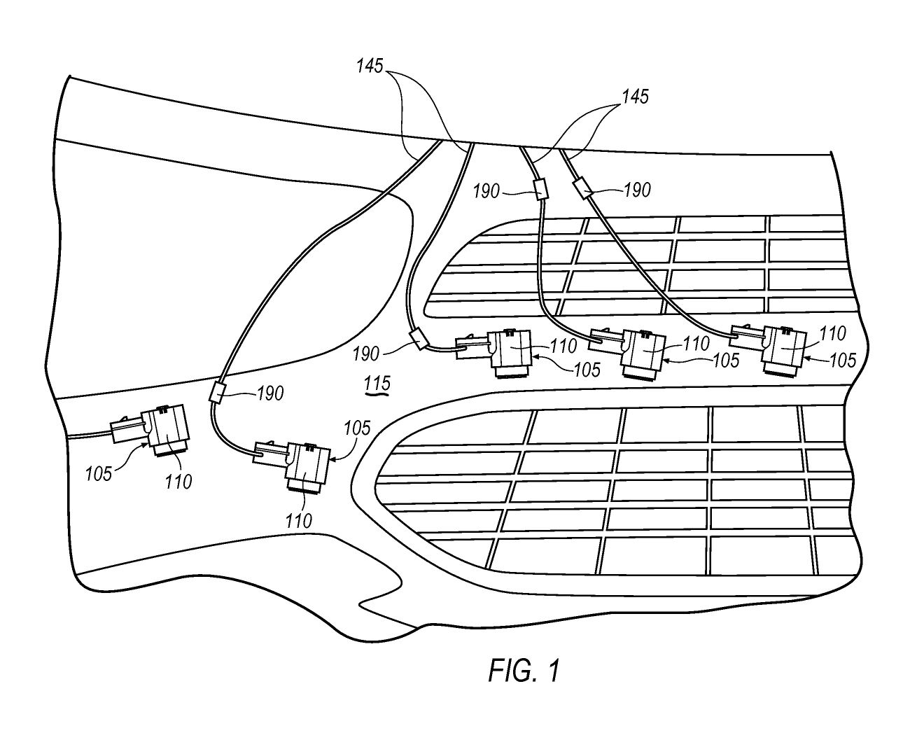

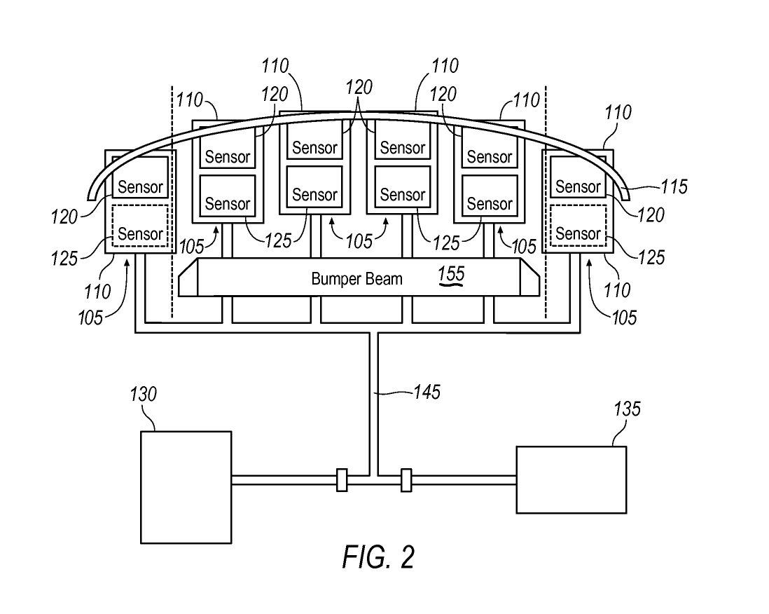

Referring to FIG. 1, a plurality of integrated sensing components 105 may be arranged on the interior of a vehicle bumper 115 (also referred to as fascia 115). Each sensing component 105 may include a housing 110 and a bracket (not shown) configured to attach to the interior of the bumper 115. An interface 145 may extend from a connector 150 (as shown in FIGS. 4-7) at each housing 110 and be coupled to at least one vehicle control module 130, 135 (shown in FIG. 2). The interface 145 may be configured to transmit data from sensors 120, 125 arranged within the housing 110 to the control modules 130, 135. The interface 145 may include an input/output system configured to transmit and receive data from the sensors 120, 125 and the control modules 130, 135. The interface 145 may be one of various busses, I/O devices, etc. The interface 145 may be one-directional such that data may only be transmitted in one direction. Additionally, the interface 145 may be bi-directional, both receiving and transmitting data between the control modules 130, 135 and sensors 120, 125.

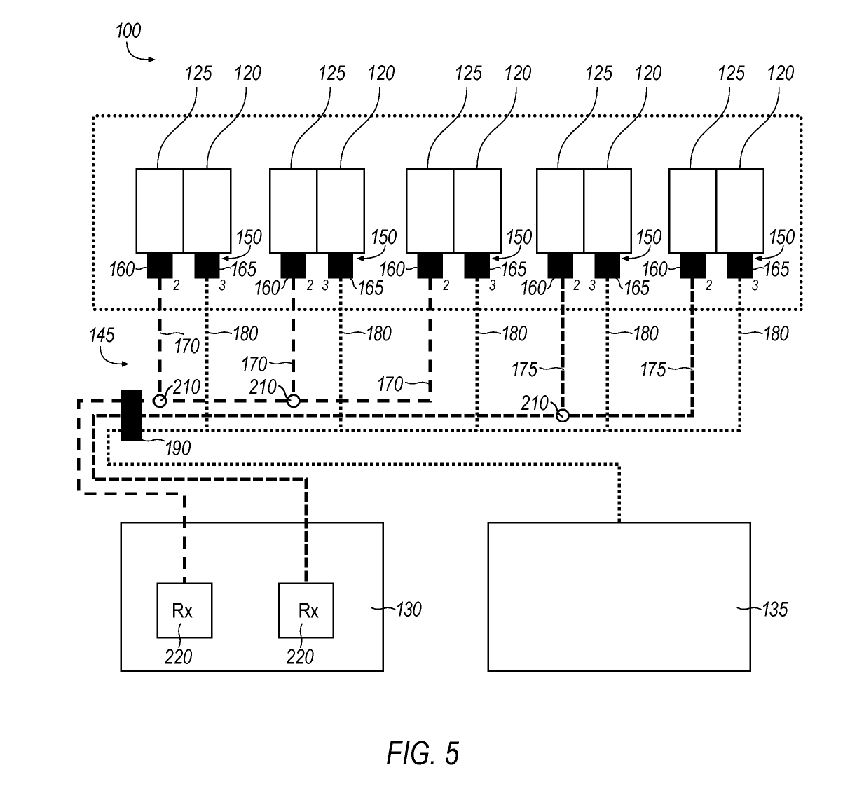

A fascia connector 190 may be a cable harness capable of maintaining the interfaces 145 against the inside of the bumper 115. The fascia connector 190 may hold the interfaces 145 (or wires) against the bumper 115 and maintain the wires in a fixed position to maintain the interfaces 145 in a fixed position. The fascia connector 190 may also include various connectors configured to receive the interfaces 145. The connector 190 may be capable of transmitting data and messages there through via circuitry and pin connections. The fascia connector 190 is also shown in FIGS. 5-7.

FIG. 2 is a schematic view of a sensing system 100 and shows the plurality of sensing components 105 being located on the inner façade of the vehicle bumper 115. The sensing components 105 may be distributed and attached to the inside of the bumper 115 via the bracket. The components 105 may be located between the bumper 115 and a bumper beam 155. The vehicle control modules 130, 135 may include a first control module, such as a parking aid module (PAM) 135, and a second control module, such as a control module (RCM) 130. Restraint control module 130 may receive signals from one or more vehicle sensors and executes programmed logic to control vehicle occupant and pedestrian protection systems/devices. Among the systems/devices controlled by restraint control module 130 are occupant restraints and deployable pedestrian protection devices such as a hood lifter. These modules 130, 135 may be in communication with the sensing component 105 via the interface 145 and are discussed in more detail below.

The bracket may be made of a material that is compatible with the fascia 115 to allow the bracket to be welded thereto. The bracket material may provide enough strength and stiffness to withstand substantial temperature and element variances. For example, the bracket material may be structurally sound to withstand high temperature of up to 400 degrees Celsius. The material may also be capable of withstanding large amounts of vibration without breaking, cracking, deteriorating, etc. Furthermore, the bracket material may not interfere with the sensors 120, 125 functions.

The bracket may be welded to the fascia 115 via ultrasonic welding, vibration welding, or other methods. The bracket may retain the sensors 120, 125 in a fixed position on the inside of the bumper 115 in the x, y and z-axis. The bracket may define a gap (not shown) between the bracket and the fascia 115 in order to meet gap strategies and guidelines. The bracket may be large enough to maintain the housing 110 on the bumper 115, but not larger than necessary so as to not take up undue space on the bumper 115. The bracket may have a thickness of approximately 1.4 mm-1.8 mm.

Each sensing component 105 may include at least one sensor. In one example, the component 105 may include a pair of sensors 120, 125 including a first sensor or a parking sensor 120, corresponding to a parking aid system within the parking aid module 135, and a second sensor or an impact sensor 125, corresponding to the restraint control module 130. At least one of the components 105 may comprise both sensors 120, 125, while the remaining portion may comprise only a parking sensor 120. In one example, it is not necessary for an impact sensor 125 to be included in an outer bumper region, as shown in FIG. 2. While the sensors 120, 125 are described as parking sensors and impact sensors, other sensors may also be housed in the housing 110.

The housing 110 may be made of a plastic material that does not interfere with the functions of the sensors 120, 125. The housing material may be the same material as that used for the bracket and/or the impact sensor 125 (e.g., polybutylene terephthalate with 30% reinforced glass fiber (PBT-30).)

The housing 110 may be optimally sized so as to contain both sensors 120, 125. The housing 110 is to be large enough to encapsulate both sensors 120, 125 but no larger than necessary so as to not take up undue space between the bumper 115 and the bumper beam 155. The housing 110 may be mechanically attached to the bracket. Poke-yoke mechanisms may be used to ensure there is no failure when connecting the housing 110 and the bracket.

A parking sensor 120 may be an ultrasonic sensor or transducer capable of transmitting, receiving, and evaluating an echo in response to a transmitted frequency sound wave to determine the distance between the sensor and an object. The parking sensor 120 may be used to determine the distance the vehicle bumper 115 is from an object, e.g., another car. The sensor 120 shall detect stationary, receding and approaching objects within a specified detection area (e.g., within a certain radius of the sensor) without detecting ground objects or other objects integral to the vehicle. The sensor 120 may include both short range sensors having an approximate detection range of 10-225 cm and long range sensors have an approximate detection range of 10-400 cm. The parking sensors 120 may also be fully operable for temperatures between 40 degrees Celsius and 80 degrees Celsius, for pressures between 50 Kpa and 120 Kpa, and humidity ranges between 5% and 95% at temperatures of 65 degrees Celsius with a 5% variance. Additionally, the sensor 120 may be able to adjust and operate as the environment changes. That is, as the ambient temperature changes, so shall the sensitivity of the sensor. Moreover, the sensor 120 shall be capable of being installed in vehicles with plastic and metal bumpers 115 without its performance being affected.

An impact sensor 125 may be an accelerometer or g-sensor capable of detecting an impact. The impact sensor 125 may be configured to detect a force at the impact sensor 125. That is, if an object comes into contact with the vehicle bumper 115 with sufficient force to cause the bumper to deflect rearward (relative to the vehicle overall), the impact sensor 125 will detect the impact. The displacement of the sensor caused by the impact may be used to determine a classification for the object causing the displacement. For example, a pedestrian may cause a greater displacement of the sensor than another, smaller object such as a ball. That is, when a ball or other relatively light object comes into contact with the bumper 115 of the vehicle, the resulting deflection of the bumper 115 may be less than if a relatively heavy object (pedestrian or other vehicle, for example) was the cause of the displacement. By classifying the object based on its impact, the restraint control module 130 may be capable of further determining the proper vehicle response (e.g., to lift the hood of the vehicle or not.) The data transmitted from the impact sensor 125 to the restraint control module 130 may be impact data indicative of the force. The impact sensor 125 may have a sensing rate of at least +/−480 g. The impact sensor 125 may have a tolerance of approximately +/−8% or better.

Each sensor 120, 125 may interface with at least one of the restraint control module 130 and the parking aid module 135. That is, data from the sensors 120, 125 may be transmitted to the modules 130, 135 via the interface 145. The interface 145 may include a plurality of interfaces 145, one for each sensor 120, 125. Additionally or alternatively, a pair of sensors 120, 125 may share an interface 145. The interface 145 may be connected to the sensors 120, 125 via a connector 150 within a common connector system including a male and female pin connection. As described below with respect to FIGS. 5, 6 and 7, the connector 150 may include a plurality of connectors. Additionally or alternatively, a single connector 150 may also be used to connect one or more interfaces 145 to a pair of sensors 120, 125. The modules 130, 135 may selectively use the transmitted data for each of their respective functions. Some synergies exist between the restraint control module 130 and the parking aid module 135. For example, similar wiring, protocols and data may be used by each module. Each module may use data from one or both of the sensors 120, 125.

The parking aid module 135 may facilitate certain features to aid the driver in parking the vehicle. For example, the parking aid module 135 may alert the driver as to when the vehicle is approaching an external object, such as another car, street sign, etc. This may be done via an audio signal through the vehicle's speakers and/or a visual graphic on the infotainment display or in the instrument cluster. In another example, the parking aid module 135 may provide data to a steering system to automatically park the vehicle, as well as determine whether a vehicle is capable of fitting into a certain parking spot.

Additionally, the parking aid module 135 may provide data to a steering system within the vehicle to park the vehicle without user interaction. That is, the parking aid module 135 may provide data to the steering system to control the vehicle's steering mechanism to effectively and safely park the vehicle without user steering interaction.

The parking sensor 120 may operate in one of two modes based on commands received via the interface 145 from the parking aid module 135. A first mode may be a transmit-receive mode. A second mode may be a listening mode. The parking aid module 135 may command the sensor 120 to transmit an ultrasonic burst, or a frequency sound wave, during the first mode. Once the sound wave has been transmitted, the module 135 may instruct the sensor 120 to listen for an echo in response to the transmitted frequency. If no echo is received, the module 135 may determine that no object is in a proximity of the sensor 120. If an echo is received, the sensor 120 and/or module 135 may evaluate the echo, as well as data from adjacent sensors 120. The sensor 120 may maintain an internal timer capable of tracking the response time (or flight time) of an echo signal (e.g., the amount of time between the transmitted frequency and the received echo). The flight time may be transmitted to the module 135, which in turn may determine the distance between the object and the sensors 120.

The restraint control module 130 may be configured to manage certain safety features of the vehicle. For example, it may manage safety features within the vehicle such as the airbags and seatbelt restraints. It may also manage certain exterior safety features such as the pedestrian protection system. This system may be configured to react to an indication that the vehicle has come into contact with a pedestrian (e.g., impact detected by the impact sensor 125). In one example, the pedestrian protection system may instruct the hood of the vehicle to lift, or elevate in an effort to lessen the impact of the pedestrian upon coming into contact with the front of the vehicle.

In addition to using the impact data from the impact sensor 125, the restraint control module 130 may also use the distance data from the parking sensor 120. In one example, the restraint control module 130 may use the distance data to be put on alert that an impact determination may be likely in the future. For example, if the distance data indicates that the vehicle is approaching an object, the restraint control module 130 may enter an alert mode, whereby it may be extra sensitive to the impact data received from the impact sensor 125. That is, by detecting that an object is being approached by the vehicle, the ability for the vehicle to react to an impact (e.g., adjust the vehicle's hood accordingly) may be increased.

The impact sensor 125 may communicate with the restraint control module 130 via the interface 145. The interface 145 may be one of a plurality of interfaces (as shown in FIGS. 5-7). The interface 145 may implement a Peripheral Sensor Interface (PSI-5) protocol (version 1.3 or later) in Synchronous Mode. The interface 145 may operate at an 8 micro-second bit rate, 10 bit data word, 1 parity bit, 500 micro-second data rate, synchronous operation with 3 calibratable timeslots per P10P-500/3L mode, initialization parameter of k=4, and a point-to-pint or parallel bus mode topology. The impact sensors 125 may transmit certain sensor data to the module 130 such as a protocol revision, number of data blocks, manufacturer code, sensor type, sensor parameters, date of production, lot and serial number, among other data.

The parking sensor 120 may also communicate with the parking aid module 135 via the interface 145. The interface 145 may be one of a plurality of interfaces 145 and may be distinct from the interface 145 transmitting the impact data.

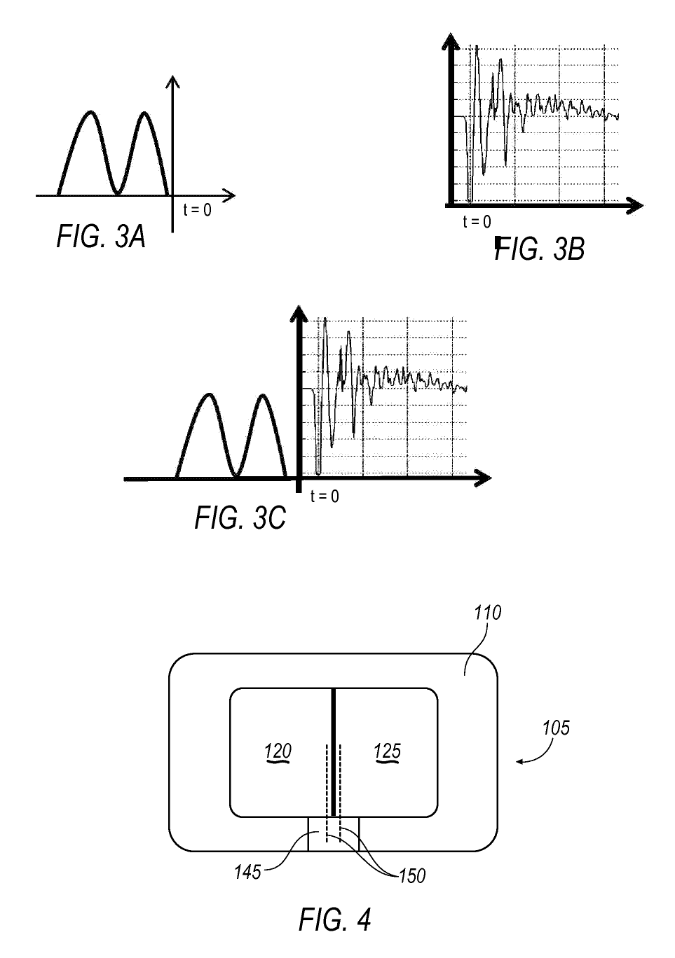

An exemplary data representation is shown in FIGS. 3A-3C. Data may be received from the sensors 120, 125 both before and after impact, which is represented at t=0 for graphical purposes. FIG. 3A shows a data representation for exemplary distance data acquired from the parking sensor 120. FIG. 3B shows a data representation for exemplary impact data acquired from the impact sensor 125. FIG. 3C shows a data representation for both the distance data and the impact data. As explained, the restraint control module 130 may use the impact data to adjust certain exterior components of the vehicle (e.g., hood) upon determining that an impact has occurred. The parking aid module 135 may use the distance data from the parking sensor 120 for parking purposes. However, data sharing may be accomplished in that both types of data may be used by either module. For example, the restraint control module 130 may use the distance data and the impact data to better adjust for contact with a pedestrian. That is, the component 105 may allow the vehicle to respond appropriately to both distance data and impact data. FIG. 4 shows a top transparent view of an exemplary integrated sensing component 105 for the vehicle sensing system 100. As explained, the exemplary component 105 may include a housing 110 configured to attach to the inside of a vehicle bumper 115 via a bracket (not shown). The housing 110 may be configured to hold and maintain the pair of sensors 120, 125 within it. The housing 110 may also be configured to hold and maintain the interface 145. The bracket may include an attachment mechanism configured to easily and efficiently attach the component 105 to the vehicle bumper 115. The housing 110 may also define an opening or a non-obstructed portion so that the sensors 120, 125 are exposed and free from obstructions for sending and receiving signals.

The interface may be a plurality of interfaces and each interface 145 may facilitate communication between the sensors 120, 125 and the respective vehicle modules 130, 135. As explained above, the interface 145 may be configured to communicate data between the modules 130, 135 and sensors 120, 125 via a pin-connection (e.g., connector(s) 150) at the housing 112. The output to the modules 130, 135 may be facilitated by a 2-pin connector 150 using Peripheral Sensor Interface (PSI-5). That is, information and data from both sensors 120, 125 may be transmitted over the same interface 145 using the same pins and circuit boards. Additionally or alternatively, a 5-pin connector may be used to transmit the combined data from the sensors 120, 125. The plurality of interfaces 145 and their connections with the sensors 120, 125 and modules 130, 135 are described in more details herein with respect to FIGS. 5-7.

FIG. 5 shows an exemplary system diagram of a sensing system 100 where the connector 150 of each sensing unit 105 includes a first sub-connector 160 connected to the impact sensor 125 and a second sub-connector 165 connected to the parking sensor 120. The interface 145 may include a plurality of interfaces 170, 175, 180. A first sub-set of the impact sensors 125 is connected via a first interface 170 to transmit impact data to a receiver 220 at the restraint control module 130. A second sub-set of the impact sensors 125 is connected via a second interface 175 to the restraint control module 130. The second connectors 165 may connect to the parking sensors 120 to transmit distance data via a third interface 180 to the parking aid module 135. Thus, a separate connector 150 and a separate interface 145 [not labeled in FIG. 5] may transmit data from each sensor 120, 125 to the modules 130, 135. The interfaces 170, 175, 180 may be a PSI-5 bus. The first and second interfaces 170, 175 may splice at least once, as shown by splice 210 in the figures.

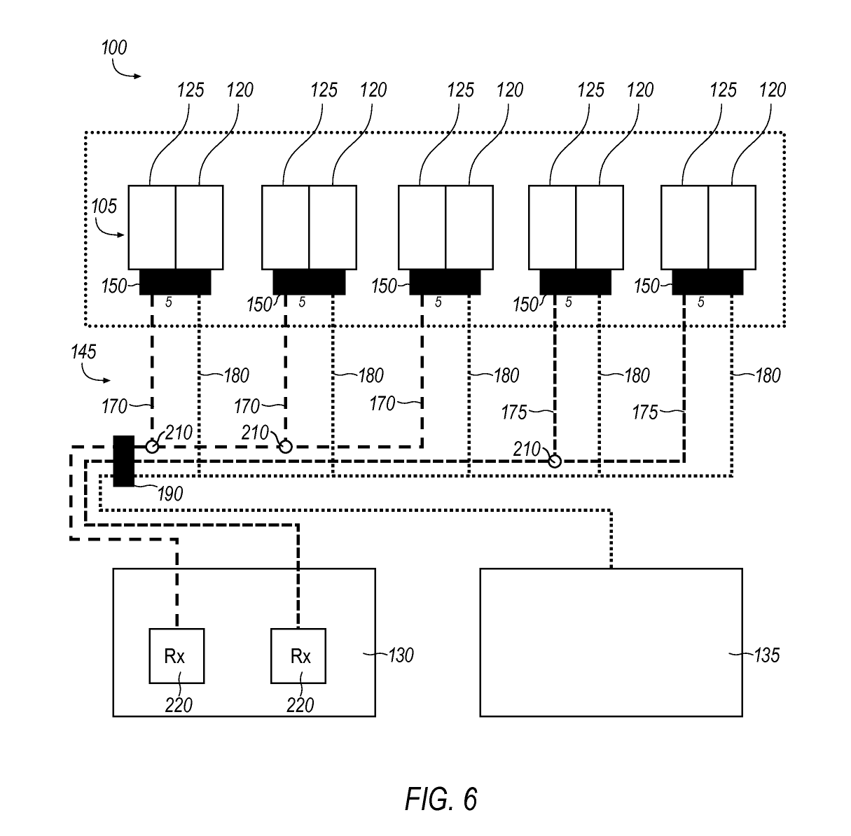

The first connectors 160 may be 2-pin connectors and the second connectors 165 may be 3-pin connectors. The first and second interfaces 170, 175 may transmit impact data to the restraint control module 130 using communication timeslots implemented in a parallel bus communication for the PSI-5 Specification. As shown in FIG. 6, in a system 100 with five sensing components 105, the impact sensors 125 of the first three components 105 may connect to the first interface 170 and the last two may connect to the second interface 175. Each connector 160, 165 may include visual identifications indicating connector keying. The first and second interfaces 170, 175 may connect to the restraint control module 130 at the receiver 220 or at a separate connectors (not shown) and the third interface 180 may connect to the parking aid module 135 at a connector (not shown.)

FIG. 6 illustrates a system diagram of the sensing system 100 where each sensing component 105 includes a single connector 150. Unlike the example in FIG. 5, the connector 150 in FIG. 6 connects directly to the impact sensor 125 and the parking sensor 120 within each sensing component 105. That is, while separate interfaces 145 are used to communicate with the modules 130, 135, a single connector 150 is shared by a pair of the sensors 120, 125. The connector 150 may be a 5-pin connector configured to receive at least two interfaces 145. As shown in FIG. 6, and similar to FIG. 5, the interfaces 145 may include a first, second and third interface 170, 175, 180 with respective splices 210.

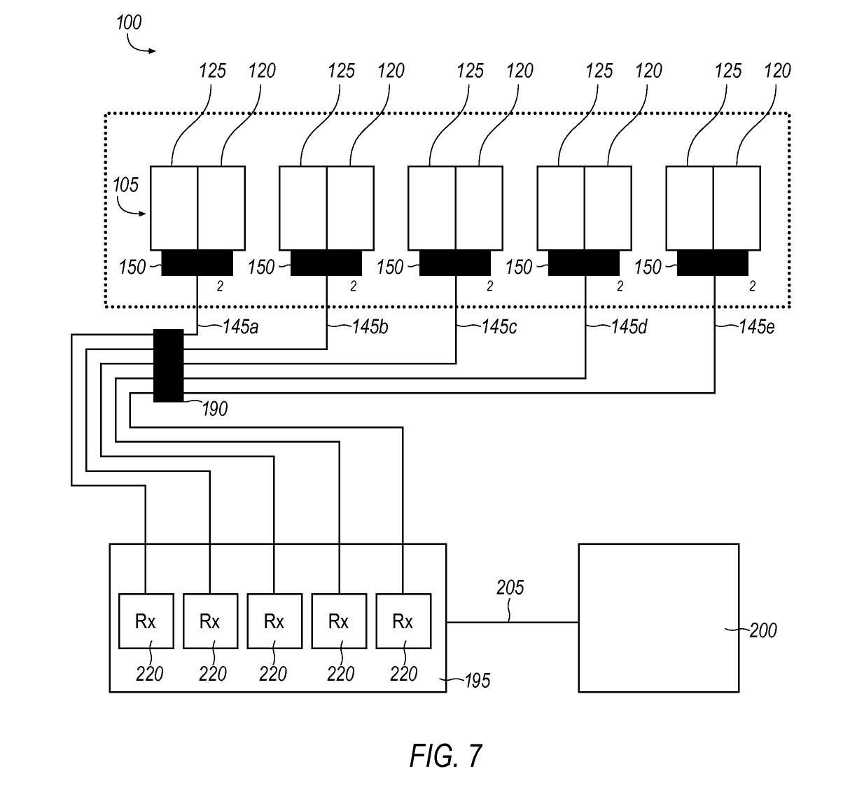

FIG. 7 illustrates a system diagram of the sensing system 100 where each sensing component 105 includes a single connector and communicates with the modules 130, 135 via a single interface 145. That is, while the example in FIG. 6 shows a single connector 150 for each sensing component 105, separate interfaces are connected at the single connector 150 for each of the impact sensor 125 and the parking sensor 120. In the current example of FIG. 7, the pair of sensors may each transmit data via the same interface 145. Each sensor pair 120, 125 may be associated with its own interface 145, as indicated in FIG. 7 as interfaces 145a, 145b, 145c, 145d, 145e. The connector 150 may be a 2-pin connector.

Because the pair of sensors 120, 125 share a single interface 145, the distance data and the impact data from each are transmitted over a single interface. Each of the interfaces 145a-e are held by the fascia connector 190 and transmit data from the sensors 120, 125 to one of the modules 130, 135. Unlike the examples in FIGS. 5 and 6, the interfaces 145a-e are connected to only one of the modules 130, 135. This module may be described as a first module or host module 195. The host module 195 may receive the data via the interfaces 145a-e and transmit data to a second module 200. In one example, the host module 195 may be the restraint control module 130 and the second module 200 may be the parking aid module 135. The host module 195 may be capable of filtering out the necessary data and transmitting only that data to the second module 200. For example, the host module 195 may receive impact data over the interfaces 145a-e on a first timeslot and distance data on a second time slot. The host module 195 may pass along the distance data to the second module 200 (e.g., ultrasonic module 135.)

Each of the interfaces 145a-e may be connected at the host module 195 at a separate connector (not shown). The two modules 195, 200 may also be connected via a module interface 205. The module interface 205 may be a PSI-5 bus. By transmitting both distance and impact data to the restraint control module 130/host module 195, the restraint control module 130 may make pedestrian protection deployment decisions based on both sets of data.

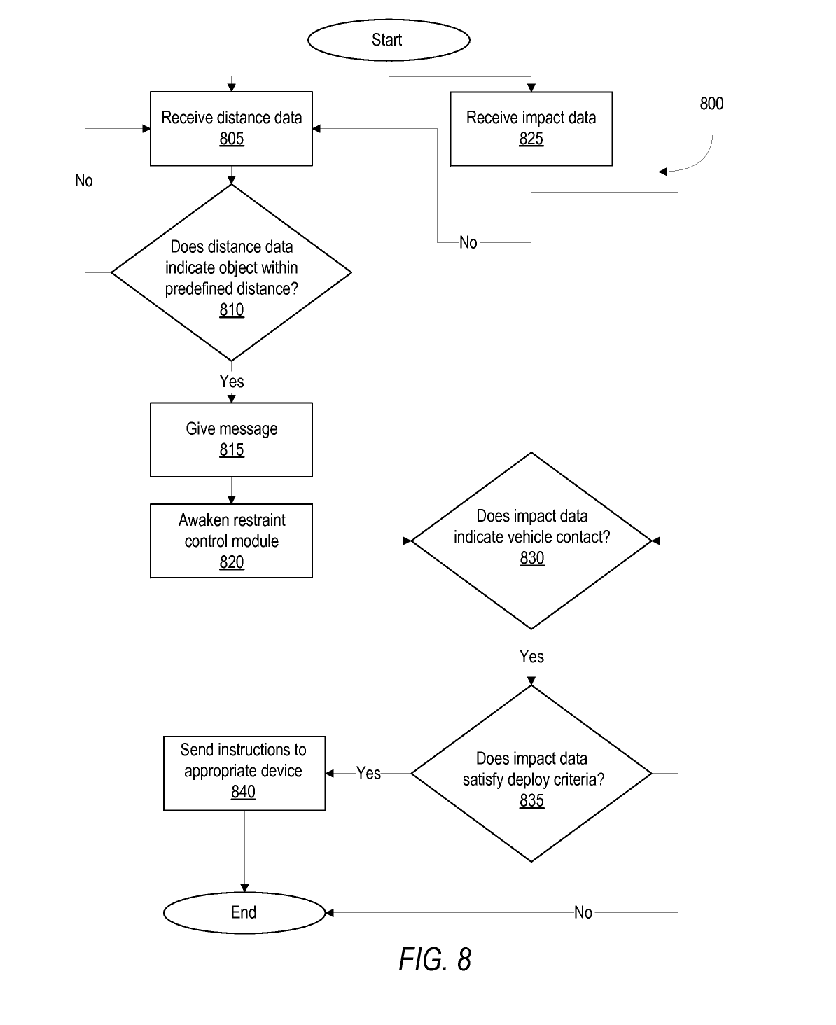

FIG. 8 is an exemplary flow chart of the sensing system 100 showing a process 800. The modules 130, 135 may implement the process 800. Additionally or alternatively a separate computing device or controller may be include (but not shown) within the vehicle to perform process 800. In one example, the parking aid module 135 may perform a portion of process 800 and the restraint control module 130 may perform another portion.

The process 800 may begin at block 805. The parking sensors 120 may transmit distance data to the parking aid module 135 via the interface 145. Additionally or alternatively, the parking sensor 120 may transmit data to the restraint control module 130, as shown in FIG. 7. In this example, the restraint control module 130 may in turn transmit the distance data to the parking aid module 135.

At block 810, the parking aid module 135 may analyze the distance data and determine whether the distance data indicates the presence of an object within a predefined distance of the sensor 120. For example, the distance data may indicate an object is within five feet of the vehicle. If an object is detected within the predefined distance of the vehicle, the process 800 may proceed to block 815. If not, the process 800 proceeds to block 805.

At block 815, upon the distance data indicating that an object is within a predefined distance of the sensor 120, the parking aid module 135 may transmit a message to the restraint control module 130. The message may be transmitted via any of the interfaces 145 via the connector 190. It may also be transmitted via a wireless signal. The message may include instructions to awaken the restraint control module 130. In the example shown in FIG. 7, the restraint control module 130 may receive the distance data and may also analyze the distance data. Additionally or alternatively, the restraint control module 130 may pass the distance data along to the parking aid module 135, and the parking aid module 135 may transmit a message back to the restrain control module 130.

At block 820, certain features of the control module 130 may awaken in response to receiving the message from the parking aid module 135. That is, certain processes may be initiated in response to receiving the message. These processes may include a process used by the pedestrian protection system. By awakening features of the control module 130, the control module 130 may be prepared to receive impact data. It may also be prepared to ready certain vehicle devices and system such as the pedestrian protection system. By readying vehicle systems, the vehicle systems may in turn prepare the vehicle for an impact and react accordingly. For example, the protection system may be able to react to an indication that the vehicle has struck a pedestrian by instructing the hood of the vehicle to lift, or elevate.

At block 825, the impact sensors 125 may transmit impact data to the restraint control module 130 via the interface 145.

At block 830, the restraint control module 130 may analyze the impact data and determine whether the impact data indicates an object or person has come into contact with the vehicle. In one example, any receipt of impact data may indicate vehicle contact. In another example, any impact data over a nominal threshold may indicate impact. For example, strong winds [really?] may cause the impact data to show some impact or displacement at the sensor 125. The wind, however, may not be a significant enough impact to register the impact with the restraint control module 130. On the other hand, if an object such as a ball, or other debris, would come into contact with the sensor 125, then the impact data may exceed the nominal threshold. If an impact is detected based on the impact data, the process 800 proceeds to block 835. If not, the process 800 proceeds to block 805.

At block 835, the restraint control module 130 may determine whether the impact data is severe enough to warrant a reaction at the vehicle. In one example, the reaction may be to activate or deploy certain pedestrian protection systems. This determination regarding the impacts' severity may be based on at least one of an acceleration, delta velocity, displacement, etc., as indicated by the impact data. If the impact is determined to be severe enough to warrant a deployment of a protection system, the process 800 may proceed to block 840. If not, the process 800 may end.

At block 840, in response to the impact data being determined to be severe, instructions may be sent to the appropriate vehicle system or device. For example, instructions, including the impact data, may be sent to the pedestrian protection system. The pedestrian protection system may then decide whether to react to the impact. The process may then end.

While process 800 describes certain functions being performed by the restraint control module 130 and the parking aid module 135, these functions are meant to be exemplary. As explained above, each module may perform any one of the described steps above. Additionally or alternatively, a separate controller or processor may perform the functions.

Accordingly, by including the pair of sensors within a single housing, it is easier for the sensors to be installed on the bumper at least because separate attachment processes are not needed for each sensor. Moreover, less surface area is needed on the bumper to accommodate for the pair of sensors. By arranging the sensors into a single housing and using a single housing component, at least five sets of parts (e.g., brackets, studs, nuts, etc.) are eliminated from the system design. Further, as explained, a single interface may be used to communicate with the various vehicle control modules. Because a single interface is being used for both sensors, a more simplified configuration may be used. That is, the wiring, circuit boards, pins, connectors and other components used by the sensors may be combined into a single, non-duplicative arrangement and thus eliminate additional elements from the system design. Moreover, the overall reliability of the sensing system may be increased. Debugging and problem solving may be reduced, as only a single interface is in communication with the various sensors and modules. That is, additional fault tolerances may be improved.

Computing devices, such as the vehicle control modules, sensors, interfaces, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc., may be interchangeable.

What is claimed is:

1. A vehicle sensing system comprising:
a plurality of sensing components, each component including a housing configured to maintain a first sensor and a second sensor;
an interface connected the first sensor and the second sensor; and
a first module and a second module connected to the interface, each configured to receive data from at least one of the first sensor and the second sensor.

2. The system of claim 1, wherein the interface includes a plurality of interfaces, each of the first and second sensors being connected to one of the interfaces.

3. The system of claim 1, wherein each of the first module and the second module are configured to receive the data via the interface, wherein each of the first module and the second module are connected to the interface.

4. The system of claim 1, wherein the first sensor is a parking sensor configured to determine a distance between the first sensor and an object.

5. The system of claim 4, wherein the second sensor is an impact sensor configured to determine an impact at the second sensor.

6. The system of claim 5, wherein the data includes at least one of distance data and impact data from the interface.

7. The system of claim 6, wherein the first module is a parking aid module configured to request an alert in response to the distance data indicating a detected object being within a predefined distance of the first sensor.

8. The system of claim 7, wherein the second module is a restraint control module configured to instruct at least a portion of the vehicle to respond to an impact identified in the impact data.

9. The system of claim 8, wherein the second module is configured to detect a possible impact based on the distance data.

10. A sensing component comprising:
a housing maintaining a parking sensor and an impact sensor; and
an interface connected to the parking sensor and the impact sensor and configured to communicate with at least one vehicle control module.

11. The component of claim 10, wherein the interface includes a plurality of interfaces, each of the distance and impact sensors being connected to one of the interfaces.

12. The component of claim 10, wherein the interface is configured to transmit data from the parking sensor and the impact sensor to the at least one vehicle control module.

13. The component of claim 12, wherein the parking sensor is a parking sensor configured to determine a distance between the parking sensor and an object.

14. The component of claim 13, wherein the impact sensor is an acceleration sensor configured to determine a displacement at the impact sensor.

15. The component of claim 14, wherein the data includes at least one of distance data and impact data from the interface.

16. A vehicle system having a first control module coupled to a sensing component within the vehicle, the module configured to:
receive distance data from the sensing component;
transmit a message to a second control module in response to the distance data indicating the presence of an object within a predefined proximity to the vehicle, the message including instructions to prepare at least one feature of the second control module to receive impact data from the sensing component.

17. The system of claim 16, wherein the second module is further configured to receive impact data from the sensing component and determine whether the impact data indicates an impact at the vehicle.

18. The system of claim 17, wherein the second module is further configured to instruct a pedestrian protection system of the vehicle to react according to the impact data in response to the impact data indicating an impact at the vehicle.

19. The system of claim 17, wherein a single interface transmits data from the sensing component to the first control module.

20. The system of claim 19, wherein the sensing component includes a connector configured to receive the interface.
